(19) United States
(12) Patent Application Publication
(10) Pub. No.: US 2026/0200106 A1
(43) Pub. Date: Jul. 16, 2026

(54) COUPLING SYSTEM FOR A GRIPPER ATTACHED TO A ROBOT

(71) Applicant: GEA Food Solutions Germany GmbH, Biedenkopf-Wallau (DE)

(72) Inventors: Maximilian Fikentscher, Kempten (DE); Konrad Klein, Stuttgart (DE); Christoph Huber, Sindelfingen (DE)

(21) Appl. No.: 19/127,826

(22) PCT Filed: Oct. 26, 2023
(86) PCT No.: PCT/EP2023/079956

§ 371 Date: May 7, 2025

(30) Foreign Application Priority Data
Nov. 9, 2022 (DE) 10 2022 211 878.2

(51) Int. Cl. B25J 19/00; F16L 23/16

(52) U.S. Cl. CPC B25J 19/0033; F16L 23/16

(57) ABSTRACT

A coupling system for a gripper attached to a robot and includes a robot-side flange and a gripper-side flange, in the robot-side flange, a first line is formed, and in the gripper-side flange a second line is formed, the robot-side flange is coupled to the gripper-side flange and secured against twisting, the gripper-side flange has a through bore that has a through bore diameter and an insertion opening with an opening width, the through bore diameter is greater than the opening width, a locking between the robot-side flange and the gripper-side flange is realized by a locking bolt arranged movably on or in the robot-side flange, the locking bolt has a first bolt diameter and a second bolt diameter, the first bolt diameter is greater than the second bolt diameter, and the first bolt diameter is greater than the opening width.

### CROSS REFERENCE TO RELATED APPLICATIONS

This application is a US National Stage Entry of PCT/EP2023/079956 filed on Oct. 26, 2023, which claims priority to DE 10 2022 211 878.2 filed on Nov. 9, 2022, the entireties of which are all hereby incorporated by reference herein for all purposes.

### FIELD

The invention relates to a coupling system for a gripper attached to a robot.

### BACKGROUND

Robots or robot systems (e.g. delta pick robots, multi-axis robots, Scara robots, etc.) are often used to increase the degree of automation when automatically loading packaging machines such as thermoforming packaging machines, tubular bag machines, tray sealing machines, etc. The products provided by an upstream process step are gripped by the robot and placed in the packaging machine. Grippers arranged on the robot are used, which can be actuated electrically, hydraulically or pneumatically. The grippers are formed differently depending on the product and must be able to be changed quickly, easily and cost-effectively depending on the production conditions.

In the food industry, such robots and grippers have to meet high hygiene standards. In particular, changing the grippers can be challenging from a hygiene point of view. In addition, changing grippers can take time, which can be a critical variable in a production facility. Another disadvantage of the prior art is that supplying of media, in particular the supplying of multiple media, for example for cooling or mechanical control of the gripper, is carried out by means of multiple external lines. Multiple external lines, such as hoses, require multiple hand movements to connect and disconnect and may restrict the robot's freedom of movement during operation.

It was thus the object of the present invention to provide a solution which does not have the disadvantages existing in the prior art and, in particular, enables hygienic gripper change and also optimizes the media routing to the gripper.

### SUMMARY

This object is solved with a coupling system for a gripper which is attached to a robot and which comprises a robot-side flange and a gripper-side flange. The robot-side flange is equipped with a line and the gripper-side flange is equipped with another line in order to convey a medium. The invention is characterized in that the robot-side flange can be coupled to the gripper-side flange in a form-fitting manner so as to be secured against twisting such that the line and the other line are in alignment in order to establish a fluidic connection with each other.

The advantage of a coupling system according to the invention is that an automated and thus hygienic gripper change is carried out. In other words, there is no need to manually replace and clean grippers, which reduces the germ load on the grippers. Furthermore, lines integrated into the coupling system optimize the design of robot systems in general and media routing in particular. In addition, a form-fitting and twist-proof connection between the robot-side flange and the gripper-side flange has the advantage that a good and play-free connection of the gripper with a precise installation position to the robot is achieved. Consequently, the invention realizes a good and simple mechanical and fluidic connection between the gripper and the robot, which increases food safety and shelf life.

The coupling system has a robot-side flange and a gripper-side flange. Both flanges can be formed in one piece with the robot or the gripper or as separate components. In addition, both flanges can each have a flat, i.e. even, end surface in order to realize good, gap-free contact between the gripper-side flange and the robot-side flange. In particular, the two flanges can have the same outer diameter and be arranged flush with each other. The coupling system also has lines and other lines.

All lines can have straight and curved sections to optimize media routing. In addition, all (other) lines can have different cross sections in some sections, for example to reduce flow resistance along a flow path or to vary flow velocities. In addition, the two flanges of the coupling system are coupled together in a form-fitting manner. A form-fitting is accompanied by the advantage that the two flanges can be oriented to each other without errors in the sense of a poka-yoke connection. As a result of such an optimized alignment of the two flanges, the lines and the other lines, in particular in an interface of the coupling system, can be arranged in alignment with each other in such a way that the transition of a medium from the lines to the other lines can take place with as little loss as possible.

Advantageous embodiments and further developments of the invention can be inferred from the subclaims and the description with reference to the drawings.

According to a preferred embodiment of the present invention, it is provided that a projection is formed on the gripper-side flange and a recess geometrically corresponding to the projection is formed on the robot-side flange. In particular, the projection can extend perpendicular to the flat end surface of the gripper-side flange. Multiple projections are also conceivable. The recess formed on the robot-side flange preferably extends perpendicular to the flat end surface of the robot-side flange, wherein the number of recesses is preferably equal to the number of projections formed on the gripper-side flange. The geometric correspondence between the projections and the recesses essentially means that a form-fitting transition fit can be realized between the two flanges to achieve twist-proofing.

According to a preferred further embodiment of the present invention, it is provided that the projection has a contour with at least one convex curvature, wherein the recess has a counter-contour with a concave curvature corresponding to the convex curvature. At least partially star-shaped or polygonal contours and counter-contours are preferred, wherein corners, tips and transition points and regions in the contour and counter-contour can be rounded. In particular, straight or curved chamfers can be provided on the recess in order to simplify insertion of the projection into the corresponding recess during a gripper change and to prevent any damage, such as abrasive wear, to the coupling system.

An advantageous embodiment of the invention provides that the gripper-side flange has a through bore open on one side, wherein the through bore has a through bore diameter and an insertion opening with an opening width, wherein the through bore diameter is greater than the opening width. In particular, the through bore open on one side can be formed on the projection. A bore axis of the through bore can be arranged perpendicular to a gripper axis. It is also conceivable that an angle greater than 0° and less than 90° is formed between the gripper axis and the bore axis. The insertion opening can advantageously be formed on a side facing the robot-side flange.

In a preferred embodiment of the invention, it is provided that a locking between the robot-side flange and the gripper-side flange can be realized by means of a locking bolt arranged movably on or in the robot-side flange. The locking bolt can comprise a head section and a shaft section. The head section can protrude from the robot-side flange and be actuated manually or by means of an actuator, while the shaft section can be arranged at least largely in the robot-side flange. It is conceivable that the locking bolt is designed to be completely removable from the robot-side flange. Preferably, the locking bolt is formed in such a way that it cannot be removed from the robot-side flange and can be moved back and forth by a displacement path between two end points. For this purpose, the locking bolt can be mounted in at least two mounting points of the robot-side flange. In particular, the mounting points can be arranged in the projection formed on the gripper-side flange, preferably in the through bore open on one side. The use of a second locking bolt is conceivable.

An advantageous embodiment of the invention provides that the locking bolt has a first bolt diameter and a second bolt diameter, wherein the first bolt diameter is greater than the second bolt diameter, wherein the first bolt diameter is greater than the opening width. Preferably, the second, i.e. smaller, bolt diameter is less than or equal to the opening width of the through bore open on one side. Furthermore, the first bolt diameter is preferably and substantially equal to the through bore diameter. An end face of a locking bolt section in which the first bolt diameter is formed can act as a stop surface for an end point of the locking bolt. It is conceivable that the stop surface rests against an inner surface of one of the two flanges on the robot or gripper side, thus specifying an end point for the position of the locking bolt.

A particularly preferred embodiment of the invention provides that a first section of the locking bolt with the first bolt diameter is movable into the through bore open on one side and is mountable therein for locking the coupling system. Preferably, the locking bolt is actuated during the coupling of the two flanges by means of the head section in such a way that a second section of the locking bolt with the second, i.e. smaller, bolt diameter is inserted into the through bore via the insertion opening. A subsequent second actuation of the head section can move the locking bolt and move the first section with the first, greater, diameter into the through bore. In this way, the first section can be mounted in the through bore and the coupling system can be locked, in particular since the first bolt diameter can be greater than the opening width of the through bore. It is conceivable that a spring is arranged in the robot- or gripper-side flange, which spring makes the second actuation unnecessary and/or at least reduces the drive energy required to actuate it.

A preferred embodiment of the invention provides that the gripper-side flange has another through bore open on one side, wherein the other through bore has another through bore diameter and another insertion opening with another opening width, wherein the locking bolt has another first bolt diameter and another second bolt diameter, wherein another section of the locking bolt with the other first bolt diameter is movable into the other through bore open on one side and is mountable therein for locking the coupling system. In particular, the two through bores, their diameters and opening widths are the same size. In addition, the first bolt diameter and the other first bolt diameter are preferably the same size. The other first bolt diameter can have another end face, which can act as another stop surface for another end point of the locking bolt. It is conceivable that the other stop surface rests against the inner surface or another inner surface of one of the two flanges on the robot or gripper side and can thus determine another end point for the position of the locking bolt.

In an advantageous embodiment of the invention, it is provided that the robot-side flange has multiple lines and the gripper-side flange has multiple other lines, wherein a number of the lines and a number of the other lines are the same. Preferably, each line is assigned exactly one other line.

According to a preferred embodiment of the invention, it is provided that the robot-side flange and/or the gripper-side flange have at least one sealing element arranged on the line and/or the other line. Preferably, multiple sealing elements, in particular made of a plastic, are arranged on the coupling system. Sealing elements can advantageously each be arranged at an end section of the lines or a start section of the other lines. Sealing elements are particularly preferably arranged in a transition region from one line to a corresponding other line. For example, sealing elements can be arranged on one of the flat end surfaces of the respective robot-side or gripper-side flange or on both end surfaces.

An advantageous embodiment of the invention provides that each line is assigned a median connection formed on an outer surface of the robot-side flange. A medium can be fed to the gripper via a media connection. Media connections can be formed in one piece with the robot-side flange. Separate media connections that can be connected to the robot-side flange are also conceivable. For example, media connections can have an outer thread and be fluidically connected to a respective assigned line by screwing via an inner thread formed in the robot-side flange.

Further details, features and advantages of the invention are apparent from the drawings, as well as from the following description of a preferred embodiment with reference to the drawings. The drawings merely illustrate an exemplary embodiment of the invention which does not restrict the essential idea of the invention.

### BRIEF DESCRIPTION OF THE DRAWINGS

FIG. 1 shows a first perspective view of an embodiment example of a coupling system according to the invention.

FIG. 2 shows a second perspective view of the coupling system according to FIG. 1.

FIG. 3 shows a third perspective view of the coupling system according to FIG. 1.

### DETAILED DESCRIPTION

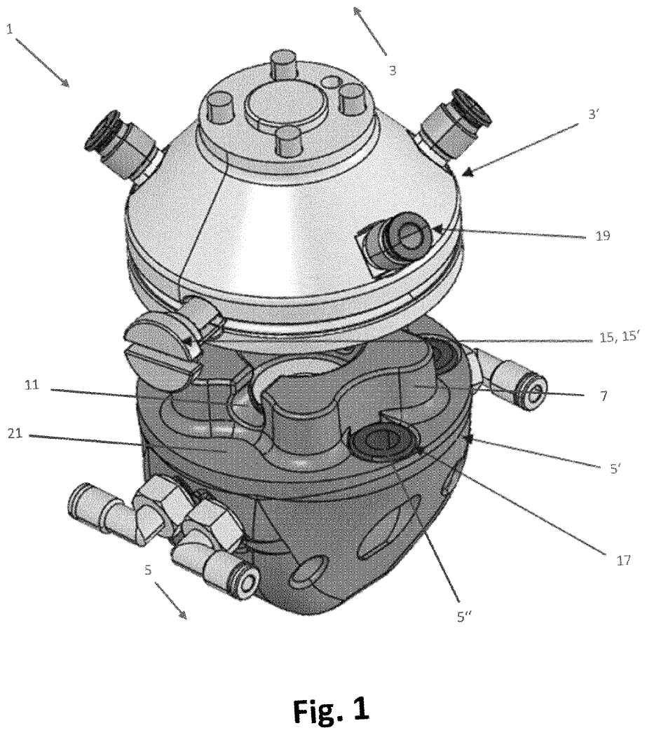

FIG. 1 shows an embodiment example of the coupling system 1 according to the invention for a gripper 5, not shown, which is connected to a robot 3, not shown. The coupling system 1 comprises a robot-side flange 3′ and a gripper-side flange 5′.

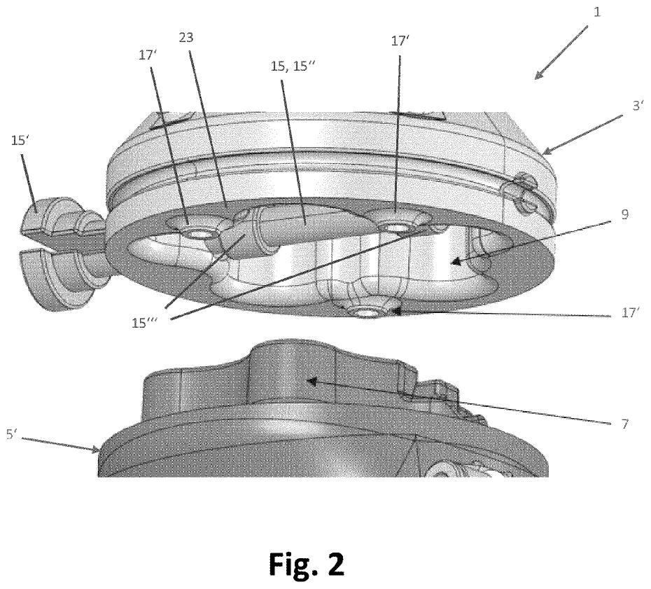

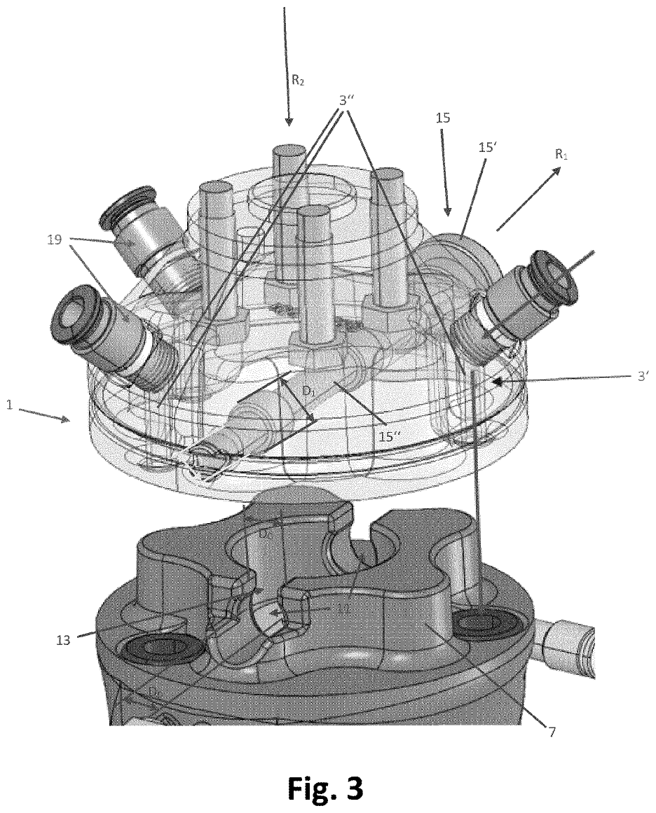

Three lines 3″ for conveying a medium are formed in the robot-side flange 3′, wherein the lines 3″ are not visible in FIG. 1 and are described in more detail in FIG. 2 and FIG. 3. Furthermore, three media connections 19 are arranged on an outer surface of the robot-side flange 3′, wherein exactly one media connection 19 is assigned to each of the three lines 3″. A flexible line is connected to the media connections 19, via which line a liquid or gaseous medium is respectively provided, which is finally conveyed to the gripper-side flange 5′ via the lines 3″ formed in the robot-side flange 3′. The conveyed media can be used for cooling, heating or control of the gripper 5, for example, and can thus also be a medium for hydraulic or pneumatic purposes.

Three further lines 5″ are formed in the gripper-side flange 5′, one of which is not visible and another of which is only partially visible in FIG. 1. The media, which are provided via the three lines 3″ formed in the robot-side flange 3′, are conveyed further into the three other lines 5″. In other words, a fluidic connection is produced between the robot-side flange 3′ and the gripper-side flange 5′. To prevent leakage or leaks, a sealing element 17 is arranged in each of the other lines 5″.

A projection 7 protrudes from a flat end surface 21 of the gripper-side flange 5′ and extends perpendicular to the end surface 21. By means of the projection 7, a form-fitting and twist-proof coupling between the robot-side flange 3′ and the gripper-side flange 5′ can be produced in interaction with a recess 9 formed in the robot-side flange 3′, which recess is visible in FIG. 2. In other words, the coupling system 1 enables both a fluidic and a mechanical connection between the robot 3 and the gripper 5.

FIG. 1 also shows that a locking bolt 15 is formed in the robot-side flange 3′. A head section 15′ of the locking bolt 15 protrudes from the robot-side flange 3′. The head section 15′ can be actuated manually or by machine, for example by means of an actuator, in order to realize a movement of the locking bolt that results in locking of the coupling system 1. When locking the coupling system 1, a shaft section 15″ of the locking bolt 15, which is visible in particular in FIG. 3, is moved into a through bore 11 open on one side, which through bore is formed in the projection 7, and is mounted therein. Geometric conditions that contribute to locking are explained in more detail in the description of FIG. 3 in particular.

FIG. 2 shows a second perspective view of the coupling system 1 from FIG. 1, looking at an inner side of the robot-side flange 3′. In the robot-side flange 3′ the recess 9 is formed, which has a counter-contour that corresponds geometrically to a contour of the projection 7. The projection 7 can be plugged/moved/guided into the recess 9 in such a way that a play-free and twist-proof fit is produced between the projection 7 and the recess 9. In other words, a form-fitting connection is produced between the robot-side flange 3′ and the gripper-side flange 5′ for moving the gripper 5 with a desired torque. To simplify assembly, the edges, rims transition region and the like are rounded or chamfered on both the projection 7 and the recess 9.

FIG. 2 also shows the shaft section 15″ of the locking bolt 15, which is arranged almost completely in the recess 9. Two different diameters are formed on the shaft section 15″. Two landings 15′″ with an enlarged cross section have a first bolt diameter D₁. The remainder of the shaft section 15″ has a second bolt diameter D₂, wherein the first bolt diameter D₁ is greater than the second bolt diameter D₂.

Furthermore, three sealing sections 17′ are formed on the robot-side flange 3′, which protrude from a flat end surface 23 of the robot-side flange 3′. When the projection 7 is inserted into the recess 9, the sealing sections 17′ are pressed against the sealing elements 17 arranged on the gripper-side flange 5′ and improve the sealing effect.

FIG. 3 shows a third perspective view 1 of the coupling system 1 according to FIG. 1. In the projection 7, two through bores 11 open on one side are formed. The through bores 11 each have a through bore diameter D_{D} and an insertion opening 13. The shaft section 15″ of the locking bolt 15 can be inserted into the through bore 11 via the insertion opening 13, which has an opening width D_{O}. For this purpose, the locking bolt 15 is actuated at the head section 15′, here pulled out of the robot-side flange 3′ in a first direction R₁, in such a way that landings of the locking bolt 15 with the smaller second bolt diameter D₂ are arranged above the insertion openings 13. The opening width D_{O} is greater than or equal to the second bolt diameter D₂, so that the locking bolt 15 can be inserted into the through bores 11 by movement in a second direction R₂. The locking bolt 15 is then actuated in the opposite direction to the first direction R₁, whereby the two landings 15″ (see also FIG. 2) with the respective larger bolt diameter D₁ are inserted into the through bore. The bolt diameters D₁ are essentially equal to the through bore diameter D_{D}, but greater than the opening width D_{O}, so that locking of the coupling system 1 is brought about by mounting the landings 15″ in the through bores 11.

FIG. 3 also illustrates the three lines 3″ formed in the robot-side flange 3′. A flow path of a medium that is fed to the gripper 5 is also indicated schematically by two arrows.

### REFERENCE SYMBOL LIST

1 Coupling system
3 Robot
3 Robot-side flange
3″ Line
5 Gripper
5 Gripper-side flange
5″ Other line
7 Projection
9 Recess
11 Through bore
13 Insertion opening
15 Locking bolt
15′ Head section
15″ Shaft section
15″ Landing
17 Sealing element
17′ Sealing sections
19 Media connection
21 End surface of the gripper-side flange
23 End surface of the robot-side flange
D_{D} Through bore diameter
D_{O} Opening width
D₁ First bolt diameter
D₂ Second bolt diameter
R₁ First direction
R₂ Second direction

1. A coupling system for a gripper which is attached to a robot and which comprises a robot-side flange and a gripper-side flange, wherein in the robot-side flange, a first line is formed, and in the gripper-side flange a second line is formed in order to convey a medium, wherein the robot-side flange is coupled to the gripper-side flange in a form-fitting manner so as to be secured against twisting such that the first line and the second line are in alignment in order to establish a fluidic connection with each other,
wherein the gripper-side has a through bore that is open on one side, the through bore has a through bore diameter and an insertion opening with an opening width, the through bore diameter is greater than the opening width,
wherein a locking between the robot-side flange and the gripper-side flange is realized by a locking bolt arranged moveably on or in the robot-side flange, the locking bolt has a first bolt diameter and a second bolt diameter, the first bolt diameter is greater than the second bolt diameter, and
wherein the first bolt diameter is greater than the opening width.

2. The coupling system according to claim 1, wherein a projection is formed on the gripper-side flange and a recess geometrically corresponding to the projection is formed on the robot-side flange.

3. The coupling system according to claim 2, wherein the projection has a contour with a convex curvature, wherein the recess has a counter-contour with a concave curvature corresponding to the convex curvature.

4. (canceled)

5. (canceled)

6. (canceled)

7. The coupling system according to claim 1, wherein a first section of the locking bolt with the first bolt diameter is movable into the through bore open on one side and is mountable therein for locking the coupling system.

8. The coupling system according to claim 7, wherein the gripper-side flange has a second through bore open on one side, wherein the second through bore has a second through bore diameter and a second insertion opening with a second opening width, wherein the locking bolt has another first bolt diameter and another second bolt diameter, wherein another section of the locking bolt with the another first bolt diameter is movable into the second through bore open on one side and is mountable therein for locking the coupling system.

9. The coupling system according to claim 1, wherein the robot-side flange has multiple first lines and the gripper-side flange has multiple second lines, wherein a number of the first lines of the robot-side flange and a number of the second lines of the gripper-side flange are the same.

10. The coupling system according to claim 1, wherein the robot-side flange and/or the gripper-side flange have at least one sealing element arranged on the first line and/or the second line.

11. The coupling system according to claim 1, wherein the first line is assigned a median connection formed on an outer surface of the robot-side flange.
